(19) United States
(12) Patent Application Publication
(10) Pub. No.: US 2016/0324366 A1
(43) Pub. Date: Nov. 10, 2016

(54) METHOD AND DEVICE FOR STARTING RICE COOKER

(71) Applicant: Xiaomi Inc., Beijing (CN)

(72) Inventors: Ke WU, Beijing (CN); Xinyu LIU, Beijing (CN)

(73) Assignee: Xiaomi Inc., Beijing (CN)

(21) Appl. No.: 15/146,305

(22) Filed: May 4, 2016

(30) Foreign Application Priority Data
May 4, 2015 (CN) 201510221433.4

(51) Int. Cl. A47J 36/32; A47J 27/00

(52) U.S. Cl. CPC A47J 36/32; A23L 1/182; A47J 27/004; A23V 2002/00

(57) ABSTRACT

The present disclosure relates to a method and a device for starting a rice cooker, and belongs to the field of smart home. The method includes: detecting whether rice and water in the rice cooker meet a cooking condition; if the rice and the water in the rice cooker meet the cooking condition, detecting whether a specified user operation is received; and if a detection result is that the specified user operation is not received, starting a cooking function of the rice cooker.

### CROSS-REFERENCE TO RELATED APPLICATIONS

This application is based upon and claims priority to Chinese Patent Application No. 201510221433.4, filed May 4, 2015, the entire contents of which are incorporated herein by reference.

### TECHNICAL FIELD

The present disclosure relates to the field of smart home, and more particularly, to a method and a device for starting a rice cooker.

### BACKGROUND

A rice cooker (usually an electric rice cooker) is one kind of indispensable kitchen household appliance in a modern home life. With the continuous development of intelligent household appliances, currently launched rice cookers also provide multiple functions, such as timing, cooking, heat insulation, and a menu for selection.

When using the rice cooker to cook rice or congee, a user needs only to put rice and water in an appropriate proportion in the rice cooker, and press a mechanical or virtual switch on an operation panel to start a cooking function of the rice cooker. The user can also select an appointment cooking function on the operation panel of the rice cooker, and set a time for starting the cooking function according to prompts. For example, the user can set the rice cooker to start cooking at 6:00 am, or start cooking after five hours, which causes the rice cooker to start the cooking function when the time set by the user arrives.

### SUMMARY

The present disclosure provides a method and a device for starting a rice cooker. According to a first aspect of embodiments of the present disclosure, there is provided a method for starting a rice cooker including detecting whether rice and water in the rice cooker meet a cooking condition, detecting whether a specified user operation is received if the rice and the water in the rice cooker meet the cooking condition, and if a detection result is that the specified user operation is not received, starting a cooking function of the rice cooker.

According to a second aspect of embodiments of the present disclosure, there is provided a device for starting a rice cooker including a processor; and a memory for storing instructions executable by the processor. The processor can be configured to detect whether rice and water in the rice cooker meet a cooking condition, determine if a specified user operation is received when the rice and the water in the rice cooker meet the cooking condition, and start a cooking function of the rice cooker when a detection result is that the specified user operation is not received.

According to a third aspect of embodiments of present disclosure, there is provided a non-transitory readable storage medium including instructions, executable by a processor in a device for starting a rice cooker, the method including detecting whether rice and water in the rice cooker meet a cooking condition,

detecting if a specified user operation is received when the rice and the water in the rice cooker meet the cooking condition, and
starting a cooking function of the rice cooker when a detection result is that the specified user operation is not received.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention, and together with the description, serve to explain the principles of the invention.

FIG. 1 is a schematic diagram illustrating an implementation environment that a method for starting a rice cooker involves, according to a part of exemplary embodiment.

FIG. 2 is a flow chart illustrating a method for starting a rice cooker, according to an exemplary embodiment.

FIG. 3 is a flow chart illustrating a method for starting a rice cooker, according to another exemplary embodiment.

FIG. 4 is a flow chart illustrating a method for starting a rice cooker, according to further another exemplary embodiment.

FIG. 5 is a block diagram illustrating a device for starting a rice cooker, according to an exemplary embodiment.

FIG. 6 is a block diagram illustrating a device for starting a rice cooker, according to another exemplary embodiment.

FIG. 7 is a block diagram illustrating a device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with some aspects related to the invention as recited in the appended claims.

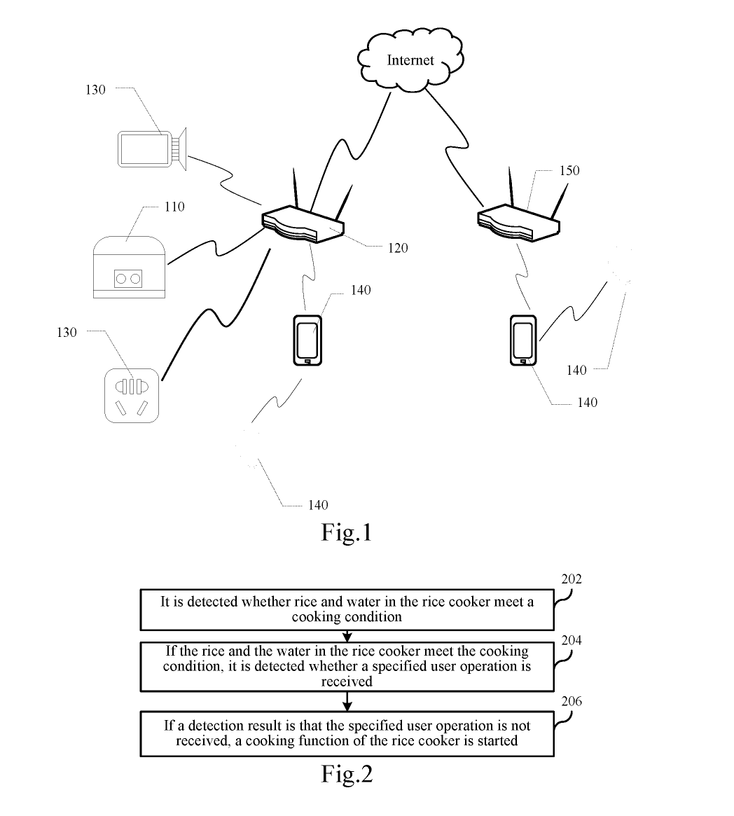

FIG. 1 is a schematic diagram illustrating an implementation environment that a method for starting a rice cooker involves, according to some of exemplary embodiments. The implementation environment can include a rice cooker 110, a first smart router 120, at least one smart household appliance 130, and at least one mobile terminal 140.

The smart household appliance 130 may include a smart television, a lighting device, a security device, a smart air conditioner, a smart refrigerator, a smart socket, and the like.

The mobile terminal 140 may be a smart mobile phone, a tablet, an ebook reader, a smart band, a smart watch, smart glasses, and the like.

The rice cooker 110, at least one smart household appliance 130, and at least one mobile terminal 140 can be connected to a home smart network via the first smart router 120. The rice cooker 110 and at least one smart household appliance 130 can be connected with the first smart router 120 using a short distance wireless communication mode. The at least one mobile terminal 140 may be connected with the first smart router 120 using the short distance wireless communication mode or via an operator network, for example.

In addition, the implementation environment may further include a second smart router 150. The first smart router 120 can be connected to the second smart router 150 through internet. The second smart router 150 can also be connected to the smart household appliance 130 and the mobile terminal 140.

FIG. 2 is a flow chart illustrating a method for starting a rice cooker, such as the rice cooker 110, according to an exemplary embodiment.

In step 202, it can be determined whether rice and water in the rice cooker 110 meet a cooking condition.

In step 204, if the rice and the water in the rice cooker 110 meet the cooking condition, it can be determined whether a specified user operation is received.

In step 206, if a detection result is that the specified user operation is not received, a cooking function of the rice cooker can be started.

Optionally, determining whether rice and water in the rice cooker 110 meet the cooking condition includes detecting whether there are weights in the rice cooker 110 via a pressure sensor provided on a bottom of a pan of the rice cooker, acquiring a total mass of the weights if there are weights in the rice cooker 110, heating an inner pot of the rice cooker 110 for a predetermined length of time, acquiring a temperature variation value in the inner pot of the rice cooker 110 before or after heating, determining a ratio of the rice and the water in the rice cooker 110 according to the temperature variation value and the total mass, and detecting whether the rice and the water in the rice cooker 110 meet the cooking condition according to the ratio of the rice and the water.

Optionally, before starting the cooking function of the rice cooker 110, the method further includes detecting whether an automatic starting condition is satisfied. The automatic starting condition can include: (i) after detecting that the rice and the water in the rice cooker 110 meet the cooking condition, the rice cooker 110 does not receive a specified operation within a first predetermined period of time, (ii) it is decided that a user has entered into a sleep state according to physiological parameters of the user detected by a wearable device, (iii) it is decided that there is no user activate in a room according to monitoring data of a security device in a smart home, and (iv) it is detected that a time that the rice and the water in the rice cooker 110 meet the cooking condition is in a first time interval, and each lighting device in the smart home is in a closed state.

Optionally, wherein before starting the cooking function of the rice cooker 110, the method can further include determining a starting time for starting the cooking function of the rice cooker 110. The starting a cooking function of the rice cooker 110 can includes starting the cooking function of the rice cooker when the starting time arrives.

Optionally, determining the starting time for starting the cooking function of the rice cooker 110 can include: (i) acquiring an alarm time set in an alarm device if it is detected that a time that the rice and the water in the rice cooker 110 meet the cooking condition is in a second time interval, and determining a starting time according to the alarm time, (ii) acquiring route information between a specified smart device and the rice cooker 110 and road condition information corresponding to the route information if it is detected that a time that the rice and the water in the rice cooker 110 meet the cooking condition is in a third time interval, calculating an arrival time of the specified smart device according to the route information and the road condition information, and determining the starting time according to the arrival time, (iii) determining, as the starting time, a time when the user had previously manually started the cooking function of the rice cooker 110, and (iv) using a starting time corresponding to a previously automatically determined starting time.

Optionally, the method can further include: (i) displaying prompt information to prompt whether an operation of starting the cooking function of the rice cooker 110 is cancelled before starting the cooking function of the rice cooker 110, and (ii) performing the operation of starting the cooking function of the rice cooker 110 if an instruction for cancelling the operation of starting the cooking function of the rice cooker 110 is not received within a second predetermined period of time.

Optionally, the displaying prompt information can include: (i) pushing the prompt information to a mobile terminal when it is detected that there is no user active in one or more predetermined rooms near the rice cooker 110, (ii) pushing the prompt information to a smart television when it is detected that there is a user active in the one or more predetermined rooms, and (iii) emitting a sound and/or light prompt via the rice cooker 110 when it is detected that there is a user active in the one or more rooms.

In summary, in the method for starting the rice cooker 110 provided by the embodiments of the present disclosure, it can be determined whether the rice and the water in the rice cooker 110 meet the cooking condition. If the rice and the water in the rice cooker 110 meet the cooking condition, then it can be determined whether a specified user operation is received. If the specified user operation is not received, the cooking function of the rice cooker 110 can be started. When it is detected that the rice and the water in the rice cooker have been ready and a specified operation of the user is not received, the cooking function is started automatically. Therefore, the problem of failing to cook due to the user forgetting to make a cooking operation or an appointment operation manually is avoided, and user experience is improved.

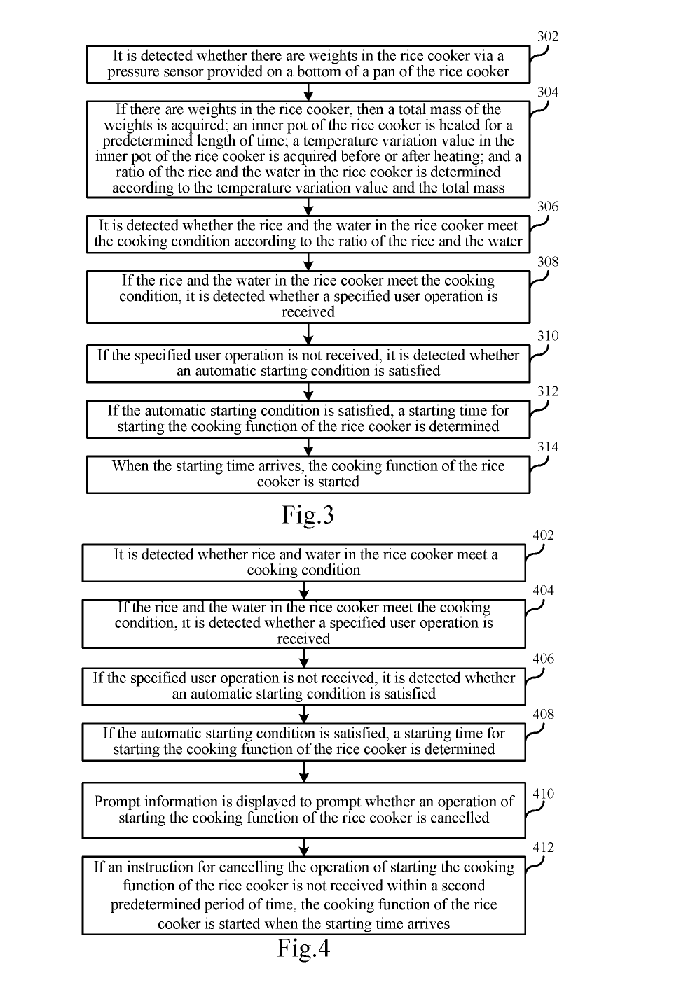

FIG. 3 is a flow chart illustrating a method for starting a rice cooker, such as the rice cooker 110, according to another exemplary embodiment.

In step 302, it can be determined if there are weights in the rice cooker via a pressure sensor provided on a bottom of a pan of the rice cooker. In embodiments of the present disclosure, the pressure sensor may be provided on the bottom of the pan of the rice cooker, and pressure parameters of the bottom of the pan may be collected by the pressure sensor. If the pressure parameter is larger than a preset parameter threshold, it may be decided that there are weights in the rice cooker.

In step 304, if there are weights in the rice cooker, then a total mass of the weights is acquired, an inner pot of the rice cooker is heated for a predetermined length of time, a temperature variation value in the inner pot of the rice cooker is acquired before or after heating, and a ratio of the rice and the water in the rice cooker is determined according to the temperature variation value and the total mass.

Specific heat capacity of the rice is different from that of the water, that is, for rice and water with the same mass, thermal energy required for raising each to the same temperature is different. The specific heat capacity C1 of the rice is about 2000 J (Kg·° C.)⁻¹, the specific heat capacity C2 of the water is about 4200 J (Kg·° C.)⁻¹. Therefore, one kilogram of rice needs to absorb only 2000 Joules of thermal energy when the temperature is increased by 1° C., and one kilogram of water needs to absorb only 4200 Joules of thermal energy when the temperature is increased by 1° C. When the rice and the water are heated together, the increased temperature of both is the same. Thereby, in the case that the specific heat capacity of the rice and the water and the total mass of the rice and the water do not vary, the ratio of the rice and the water may be calculated according to the following formulas:

$$\{ \begin{matrix}P * Δ t * α = {C}_{1} * {m}_{1} + {C}_{2} * {m}_{2} \\ M = {m}_{1} + {m}_{2} Eq . 2\end{matrix} , \qquad Eq . 1$$

It should be noted that the ratio of the rice and the water here is a mass ratio of the rice and the water, where P is a power for heating the rice cooker, Δt is a time for heating, α is a thermal efficiency of the rice cooker, M is a total mass of the rice and the water, and m₁ and m₂ are mass of the rice and the water, respectively. It can be seen that the elements of Eq. 1 and Eq. 2, except m₁ and m₂, are known in the above formulas. The above equations may be used to calculate m₁ and m₂, and then the mass ratio of the rice and the water may be obtained.

In step 306, it can be determined whether the rice and the water in the rice cooker meet the cooking condition according to the ratio of the rice and the water. After the mass ratio of the rice and the water is obtained, the rice cooker can determine whether the mass ratio is within a predetermined proportional range. If the mass ratio is in the predetermined proportional range, it may be determined that the rice and the water in the rice cooker already meet the cooking condition.

In step 308, if the rice and the water in the rice cooker meet the cooking condition, it can be determined whether a specified user operation is received. The specified user operation may be an operation of starting the cooking function or an operation for making an appointment to start cooking at a predetermined time. If a cooking operation or an appointment operation is not received within a period of time after the rice cooker detects that the rice and the water meet the cooking condition, it may be because the user forgot to make the cooking operation or the appointment operation, for example.

In step 310, if the specified user operation is not received, it can be determined whether an automatic starting condition is satisfied. The rice cooker can detect whether at least one of the following automatic starting conditions, as further described herein, is satisfied.

For example, it can be determined that a user has entered into a sleep state according to physiological parameters of the user detected by a wearable device. The wearable device of the user can collect the physiological parameters of the user and decide whether the user has entered into the sleep state based on the physiological parameters. After detecting that the rice and the water already meet the cooking condition, the rice cooker can inquire whether the user has entered into the sleep state based on the information from the wearable device being transmitted via a smart home network. If the user does not enter into the sleep state, the rice cooker can wait for the user to activate the cooking operation or the appointment operation. If the user has entered into the sleep state, the rice cooker determines that the user forgot to make the cooking operation or the appointment operation, and the automatic starting condition is satisfied.

In another example, it can be determined that there is no user active in one or more rooms near the rice cooker according to monitoring data of a security device in a smart home.

The security device in the smart home can monitor user activities and behaviors in the room via a detection device, such as a camera or an infrared alarm device. After detecting that the rice and the water already meet the cooking condition, the rice cooker can inquire, via the smart home network, if there is a user active in the one or more rooms based on the output from security device transmitted to the rice cooker. If there is user active, the rice cooker can wait for the user to activate the cooking operation or the appointment operation. If there is no user active, the rice cooker can determine that the user forgot to activate the cooking operation or the appointment operation, and the automatic starting condition is satisfied.

Further, it can be determined that a time that the rice and the water in the rice cooker meet the cooking condition is in a first time interval, and one or more predetermined lighting devices in the smart home is in a closed state (i.e., turned off). For example, when the rice cooker detects that the time that the rice and the water meet the cooking condition is between 6:00 pm to 12:00 pm, the rice cooker can inquire about the state of the one or more lighting devices in the smart home via the smart router in the smart home. If the one or more predetermined lighting devices is in the closed state, the user may have been away or have fallen asleep, for example. The rice cooker may then determine that the user forgot to activate the cooking operation or the appointment operation, and the automatic starting condition is satisfied.

In step 312, if the automatic starting condition is satisfied, a starting time for starting the cooking function of the rice cooker can be determined. Optionally, the starting time may be determined by the rice cooker through one of the following methods as further described herein.

If it is determined that a time that the rice and the water in the rice cooker meet the cooking condition is in a second time interval, an alarm time set in an alarm device can be acquired, and a starting time can be determined according to the alarm time. For example, if detecting that the time that the rice and the water meet the cooking condition is after 9:00 pm, the rice cooker can assume that the rice and the water may be prepared for breakfast next morning by the user. At this time, the rice cooker can acquire the alarm time set in the smart mobile phone of the user or an alarm clock, and determine the starting time according to the alarm time. For example, a time point of 20 minutes before the alarm time can be the starting time.

If it is determined that a time that the rice and the water in the rice cooker meet the cooking condition is in a third time interval, route information and road condition information corresponding to the route information can be acquired by the rice cooker from a predetermined smart device. An arrival time of the specified smart device can be calculated according to the route information and the road condition information, and the starting time can be determined according to the arrival time. For example, if the rice cooker detects that the time that the rice and the water meet the cooking condition is in the daytime, the rice and the water may be prepared for lunch or dinner that day by the user. At this time, if the user is not in the one or more predetermined rooms near the rice cooker, the route information and road condition information corresponding to the route information transmitted between the smart phone of the user and the rice cooker may be acquired via the smart router. A time for the user to get home may then be estimated in combination with a current time, and the starting time may be determined according to the time for the user to get home. For example, if the time for the user to get home is 6:00 pm, the rice cooker can set the starting time to 5:40 pm.

Additionally, a time when the user had previously manually started the cooking function of the rice cooker can be determined as the starting time. The rice cooker can also determine the time when the user had previously manually started the cooking function of the rice cooker as the starting time. For example, if the user manually started the cooking function of the rice cooker at 7:00 am, the rice cooker can automatically set the starting time to 7:00 am the next morning.

A starting time can be automatically determined based on the most recent manually activated starting time. The rice cooker can automatically determine the starting time based on the user having previously forgotten to cook rice. For example, if the most recent starting time automatically determined by the rice cooker is 6:40 am, the rice cooker can set the starting time as 6:40 am the next morning.

In step 314, when the starting time is reached, the cooking function of the rice cooker can be activated. Optionally, since the mass ratio of the rice and the water for cooking rice is different from that for cooking congee, in the embodiments of the present disclosure, before the cooking function is started, a cooking mode may also be decided through the mass ratio of the rice and the water obtained in step 304. The cooking mode may include cooking rice or congee. When the starting time is reached, the cooking function of the rice cooker can be started according to the determined cooking mode.

In summary, in the method for starting a rice cooker provided by the embodiments of the present disclosure, whether the rice and the water in the rice cooker meet the cooking condition can be detected. If the rice and the water in the rice cooker meet the cooking condition, then it can be determined whether a specified user operation is received, and if the specified user operation is not received, the cooking function of the rice cooker is started. When it is detected that the rice and the water in the rice cooker have been ready and a specified operation of the user is not received, the cooking function can be started automatically. The problem of failing to cook due to the user forgetting to activate a cooking operation or an appointment operation manually can be avoided, and the user experience may be improved.

Furthermore, in the method for starting a rice cooker provided by the embodiments of the present disclosure, the cooking mode can be determined according to the mass ratio of the rice and the water. When the starting time is reached, the cooking function of the rice cooker can be started according to the determined cooking mode. The user does not need to set or select manually, and user experience may be further improved.

FIG. 4 is a flow chart illustrating a method for starting a rice cooker, such as the rice cooker 110, according to further another exemplary embodiment.

In step 402, it can be determined whether rice and water in the rice cooker meet a cooking condition.

In step 404, if the rice and the water in the rice cooker meet the cooking condition, it can be determined whether a specified user operation is received.

In step 406, if the specified user operation is not received, it can be determined whether an automatic starting condition is satisfied.

In step 408, if the automatic starting condition is satisfied, a starting time for starting the cooking function of the rice cooker can be determined.

The description of the method for determining if the rice and the water are in conformity with the cooking condition and the automatic starting condition can be determined as in steps 302-312 in corresponding embodiments.

In step 410, prompt information can be displayed to prompt whether an operation of starting the cooking function of the rice cooker is cancelled.

When it is determined that there is no user active in one or more predetermined rooms near the rice cooker, the rice cooker can push the prompt information to a mobile terminal. For example, when it is detected that there is no user active in the one or more rooms via a security device in a smart home, the rice cooker can push the prompt information to the mobile terminal, such as a smart mobile phone, to inform the user that the starting of the rice cooker is cancelled.

When it is detected that there is user active in the room, the rice cooker can push the prompt information to a smart television. For example, when it is detected that there is user activate in the room via the security device in the smart home, the rice cooker can push the prompt information to the smart television to inform the user whether or not the starting of the rice cooker is cancelled. If the smart television is in an open state (i.e., turned on), the prompt information can be directly displayed at a predetermined position on a screen of the smart television. If the smart television is in a closed state (i.e., turned off), the smart television can be automatically turned on and the prompt information can be displayed at the predetermined position on the screen of the smart television.

When it is detected that there is a user active in the one or more rooms, the rice cooker can emit a sound and/or light prompt. For example, when it is detected that there is a user active in the one or more rooms via the security device in the smart home, the rice cooker can emit a prompt, such as voice, buzz, and/or flashing lights to remind the user that the rice cooker is ready to start the cooking function automatically.

When the prompt information is pushed to the mobile terminal or the smart television, the prompt information may include information including a starting time and a cooking mode.

In step 412, if an instruction for cancelling the operation of starting the cooking function of the rice cooker is not received within a second predetermined period of time, the cooking function of the rice cooker can be started when the starting time is reached. For example, after the prompt information is displayed, if the operation of cancelling the starting the cooking function by the user is not received within 10 minutes, or the operation of cancelling the starting the cooking function by the user is not received before the starting time arrives, the cooking function of the rice cooker is started automatically when the starting time arrives.

If the instruction for cancelling the operation of starting the cooking function of the rice cooker is received within the second predetermined period of time, an appointment can be cancelled. For example, after viewing the prompt information via the smart mobile phone or the smart television, the user can select a cancel button. The smart mobile phone or the smart television can push a cancel instruction to the rice cooker, and the starting operation can be cancelled by the rice cooker.

In summary, in the method for starting a rice cooker provided by the embodiments of the present disclosure, if the rice and the water in the rice cooker meet the cooking condition is detected, and if the rice and the water in the rice cooker meet the cooking condition, then it can be determined whether a specified user operation is received. If the specified user operation is not received, the cooking function of the rice cooker can be started. When it is detected that the rice and the water in the rice cooker have been ready and a specified operation of the user is not received, the cooking function can be started automatically, the problem of failing to cook due to the user forgetting to make a cooking operation or an appointment operation manually is avoided, and the user experience may be improved.

In addition, in the method for starting a rice cooker provided by the embodiments of the present disclosure, before starting the cooking function of the rice cooker, the prompt information used to prompt whether the operation for starting the cooking function of the rice cooker is cancelled can be displayed. If the instruction for cancelling the operation of starting the cooking function of the rice cooker is not received within the second predetermined period of time, the cooking function of the rice cooker can be started when the starting time is reached, so as to facilitate the user knowing a starting state of the rice cooker, thus avoiding an error detection.

Embodiments of devices of the present disclosure are described hereinafter, which may be used for performing embodiments of methods of the present disclosure. For the details not described in the embodiments of devices of the present disclosure, please refer to the embodiments of methods of the present disclosure.

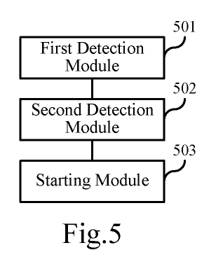

FIG. 5 is a block diagram illustrating a device for starting a rice cooker, according to an exemplary embodiment. The device for starting the rice cooker may be applicable in the rice cooker 110 shown in FIG. 1, and may be used to perform the method shown in any one of FIGS. 2-4. As shown in FIG. 5, the device for starting the rice cooker can include a first detection module 501, a second detection module 502, and a starting module 503.

The first detection module 501 is configured to detect whether rice and water in the rice cooker meet a cooking condition.

The second detection module 502 is configured to detect whether a specified user operation is received if the rice and the water in the rice cooker meet the cooking condition.

The starting module 503 is configured to start a cooking function of the rice cooker if a detection result, detected by the second detection module 502, is that the specified user operation is not received.

In summary, in the device for starting a rice cooker provided by the embodiments of the present disclosure, it can be determined if the rice and the water in the rice cooker meet the cooking condition. If the rice and the water in the rice cooker meet the cooking condition, then it can be determined if a specified user operation is received. If the specified user operation is not received, the cooking function of the rice cooker is started. When it is detected that the rice and the water in the rice cooker have been ready and a specified operation of the user is not received, the cooking function is started automatically. Therefore, the problem of failing to cook due to the user forgetting to make a cooking operation or an appointment operation manually can be avoided, and the user experience may be improved.

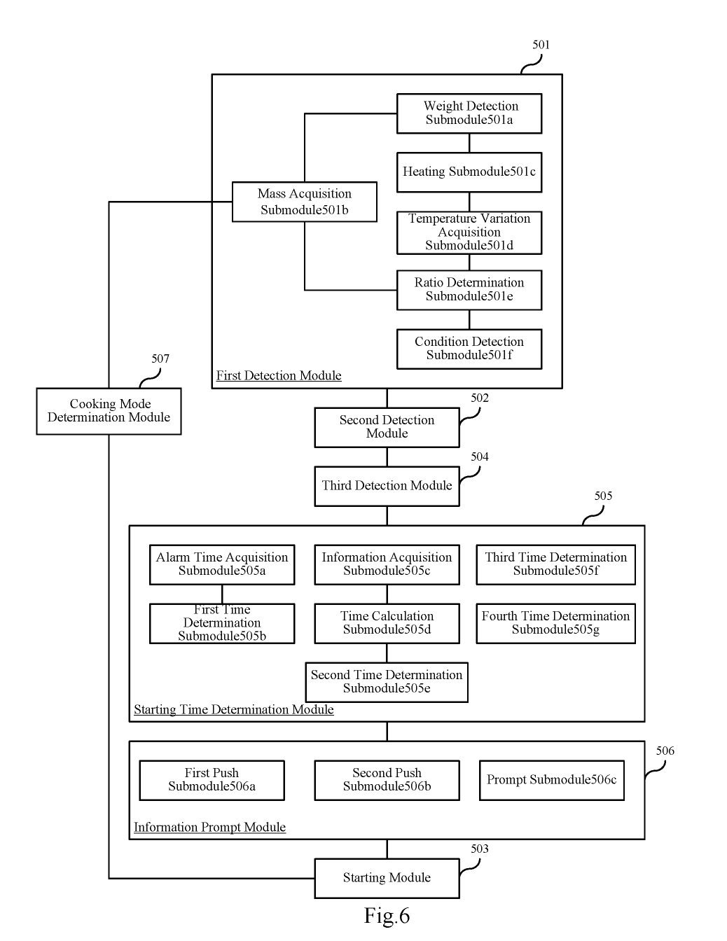

FIG. 6 is a block diagram illustrating a device for starting a rice cooker, according to another exemplary embodiment. The device for starting the rice cooker may be applicable in the rice cooker 110 shown in FIG. 1, and may be used to perform the method shown in any one of FIGS. 2-4. As shown in FIG. 5, the device for starting the rice cooker can include the first detection module 501, the second detection module 502, and the starting module 503.

Optionally, the first detection module 501 can include a weight detection submodule 501a, a mass acquisition submodule 501b, a heating submodule 501c, a temperature variation acquisition submodule 501d, a ratio determination submodule 501e, and a condition detection submodule 501f.

The weight detection submodule 501a can be configured to detect if there are weights in the rice cooker via a pressure sensor provided on a bottom of a pan of the rice cooker.

The mass acquisition submodule 501b can be configured to acquire a total mass of the weights if there are weights in the rice cooker.

The heating submodule 501c can be configured to heat an inner pot of the rice cooker for a predetermined length of time.

The temperature variation acquisition submodule 501d can be configured to acquire a temperature variation value in the inner pot of the rice cooker before or after heating.

The ratio determination submodule 501e can be configured to determine a ratio of the rice and the water in the rice cooker according to the temperature variation value and the total mass.

The condition detection submodule 501f can be configured to detect whether the rice and the water in the rice cooker meet the cooking condition according to the ratio of the rice and the water.

Optionally, the device can further include a third detection module 504. The third detection module 504 can be configured to determine if an automatic starting condition is satisfied before the starting module 503 starts the cooking function of the rice cooker. The automatic starting condition can include

determining that a user has entered into a sleep state according to physiological parameters of the user detected by a wearable device,
determining that there is no user active in one or more rooms near the rice cooker according to monitoring data of a security device in a smart home,
determining that a time that the rice and the water in the rice cooker meet the cooking condition is in a first time interval, and determining if one or more predetermined lighting devices in the smart home are in a closed state (i.e., turned off).

Optionally, the device can further include a starting time determination module 505. The starting time determination module 505 can be configured to determine a starting time for starting the cooking function of the rice cooker before the starting module 503 starts the cooking function of the rice cooker. The starting module 503 can be configured to start the cooking function of the rice cooker when the starting time has been reached.

Optionally, the starting time determination module 505 can include an alarm time acquisition submodule 505a and a first time determination submodule 505b. The starting time determination module 505 can also include an information acquisition submodule 505c, a time calculation submodule 505d, and a second time determination submodule 505e. Additionally, the starting time determination module 505 can include a third time determination submodule 505f. The starting time determination module 505 can further include a fourth time determination submodule 505g.

The alarm time acquisition submodule 505a can be configured to acquire an alarm time set on an alarm device if it is detected that a time that the rice and the water in the rice cooker meet the cooking condition is in a second time interval.

The first time determination submodule 505b can be configured to determine a starting time according to the alarm time.

The information acquisition submodule 505c can be configured to acquire route information between a specified smart device and the rice cooker and road condition information corresponding to the route information if it is detected that a time that the rice and the water in the rice cooker meet the cooking condition is in a third time interval.

The time calculation submodule 505d can be configured to calculate an arrival time of the specified smart device according to the route information and the road condition information.

The second time determination submodule 505e can be configured to determine the starting time according to the arrival time.

The third time determination submodule 505f can be configured to determine a time when the user had previously manually started the cooking function of the rice cooker as the starting time.

The fourth time determination submodule 505g can be configured to use a starting time which is automatically determined based on the most recently provided starting time as the starting time.

Optionally, the device can further include an information prompt module 506. The information prompt module 506 can be configured to display prompt information before the starting module starts the cooking function of the rice cooker, wherein the prompt information can be used to prompt whether an operation of starting the cooking function of the rice cooker is cancelled.

The starting module 503 can be configured to perform the operation of starting the cooking function of the rice cooker if an instruction for cancelling the operation of starting the cooking function of the rice cooker is not received within a second predetermined period of time.

Optionally, the information prompt module 506 can include a first push submodule 506a, a second push submodule 506b, and a prompt submodule 506c. The first push submodule 506a can be configured to push the prompt information to a mobile terminal when it is detected that there is no user active in the one or more predetermined rooms. The second push submodule 506b can be configured to push the prompt information to a smart television when it is detected that there is a user active in the one or more predetermined rooms. The prompt submodule 506c can be configured to emit a sound and/or light prompt via the rice cooker when it is detected that there is a user active in the one or more predetermined rooms.

Optionally, the device can further include a cooking mode determination module 507. The cooking mode determination module 507 can be configured to determine a cooking mode according to the ratio of the rice and the water before the starting module 503 starts the cooking function of the rice cooker, wherein the cooking mode includes cooking rice or congee.

The starting module 503 can be configured to start the cooking function of the rice cooker according to the cooking mode.

In summary, in the device for starting a rice cooker provided by the embodiments of the present disclosure, it can be determined if the rice and the water in the rice cooker meet the cooking condition. If the rice and the water in the rice cooker meet the cooking condition, then it can be determined if a specified user operation is received. If the specified user operation is not received, the cooking function of the rice cooker is started. When it is detected that the rice and the water in the rice cooker have been ready and a specified operation of the user is not received, the cooking function can be started automatically. Therefore, the problem of failing to cook due to the user forgetting to activate a cooking operation or an appointment operation manually can be avoided, and the user experience may be improved.

Furthermore, in the device for starting a rice cooker provided by the embodiments of the present disclosure, the cooking mode can be determined according to the mass ratio of the rice and the water, and when the starting time is reached, the cooking function of the rice cooker can be started according to the determined cooking mode. Therefore, the user does not need to set or select anything manually, and the user experience may be further improved.

In addition, in the device for starting a rice cooker provided by the embodiments of the present disclosure, before starting the cooking function of the rice cooker, the prompt information used to prompt whether the operation for starting the cooking function of the rice cooker is cancelled can be displayed. If the instruction for cancelling the operation of starting the cooking function of the rice cooker is not received within the second predetermined period of time, the cooking function of the rice cooker can be started when the starting time is reached, thereby allowing the user to know a starting state of the rice cooker, thereby avoiding any error detection.

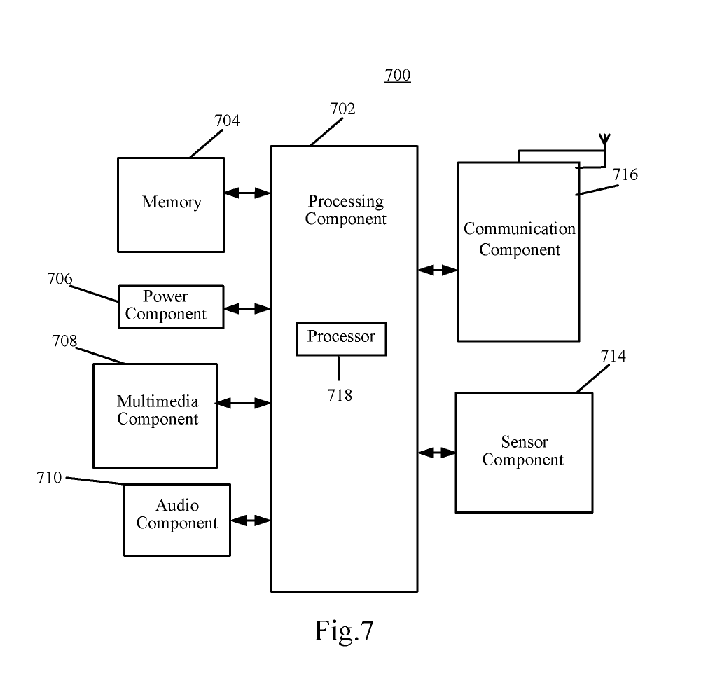

FIG. 7 is a block diagram illustrating a device 700 according to an exemplary embodiment. For example, the device 700 may be a mobile phone, a computer, a digital broadcast terminal, a messaging device, a router device, a gaming console, a tablet, a medical device, exercise equipment, a personal digital assistant, a smart control device, a smart household appliance, a smart wearable device, and the like.

Referring to FIG. 7, the device 700 may include one or more components including a processing component 702, a memory 704, a power component 706, a multimedia component 708, an audio component 710, a sensor component 714, and a communication component 716.

The processing component 702 typically controls overall operations of the device 700, such as the operations associated with display, telephone calls, data communications, camera operations, and recording operations. The processing component 702 may include one or more processors 718 to execute instructions to perform all or part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 can be configured to store various types of data to support the operation of the device 700. Examples of such data include instructions for any applications or methods operated on the device 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk. The memory 704 also stores one or more modules, the one or more modules are configured to be performed by one or more processors 718 to perform all or part of steps of the method shown in any one of the above FIGS. 2-4.

The power component 706 provides power to various components of the device 700. The power component 706 may include a power management system, one or more power sources, and any other components associated with the generation, management, and distribution of power in the device 700.

The multimedia component 708 includes a screen providing an output interface between the device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive an external multimedia datum while the device 700 is in an operation mode, such as a photographing mode or a video mode. Each of the front camera and the rear camera may be a fixed optical lens system or have focus and optical zoom capability.

The audio component 710 can be configured to output and/or input audio signals. For example, the audio component 710 can include a microphone (“MIC”) configured to receive an external audio signal when the device 700 is in an operation mode, such as a call mode, a recording mode, and a voice recognition mode. The received audio signal may be further stored in the memory 704 or transmitted via the communication component 716. In some embodiments, the audio component 710 can further include a speaker to output audio signals.

The sensor component 714 can include one or more sensors to provide status assessments of various aspects of the device 700. For instance, the sensor component 714 may detect an open/closed status of the device 700, relative positioning of components, a change in position of the device 700 or a component of the device 700, and a change in temperature of the device 700. In some embodiments, the sensor component 714 may further include a magnetic sensor, a pressure sensor, or a temperature sensor.

The communication component 716 can be configured to facilitate communication, wired or wirelessly, between the device 700 and other devices. The device 700 can access a wireless network based on a communication standard, such as WiFi, 2G, or 3G, or a combination thereof. In one exemplary embodiment, the communication component 716 receives a broadcast signal or broadcast associated information from an external broadcast management system via a broadcast channel. In one exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, a non-transitory computer-readable storage medium including instructions, such as included in the memory 704, executable by the processor 718 in the device 700, for performing the above-described methods can also be provided. For example, the non-transitory computer-readable storage medium may be a ROM, a RAM, a CD-ROM, a magnetic tape, a floppy disc, an optical data storage device, and the like.

With respect to the devices in the above embodiments, the specific manners for performing operations for individual modules therein have been described in detail in the embodiments regarding the methods, which will not be elaborated herein.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for starting a rice cooker, comprising:
detecting if rice and water in the rice cooker meet a cooking condition;
determining, via processing circuitry, if a specified user operation is received when the rice and the water in the rice cooker meet the cooking condition; and
activating a cooking function of the rice cooker when a detection result corresponds to not receiving the specified user operation.

2. The method according to claim 1, wherein the detecting if the rice and water in the rice cooker meet the cooking condition further comprises:
detecting if there are weights in the rice cooker via a pressure sensor provided on a bottom of a pan of the rice cooker;
acquiring a total mass of the weights when it is determined that there are weights in the rice cooker;
heating an inner pot of the rice cooker for a predetermined length of time based on the activated cooking function;
acquiring a temperature variation value in the inner pot of the rice cooker before or after heating;
determining a ratio of the rice and the water in the rice cooker according to the temperature variation value and the total mass; and
detecting if the rice and the water in the rice cooker meet the cooking condition based on the ratio of the rice and the water.

3. The method according to claim 1, wherein the method prior to starting the cooking function of the rice cooker further comprises:
detecting if an automatic starting condition is satisfied, wherein the automatic starting condition includes:
determining that a user has entered into a sleep state according to physiological parameters of the user detected by a wearable device;
determining that there is no user activity in one or more predetermined rooms according to monitoring data of a security device in a smart home; and
determining that a time that the rice and the water in the rice cooker meet the cooking condition is in a first time interval, and one or more predetermined lighting devices in the smart home is in a closed state.

4. The method according to claim 1, wherein before starting the cooking function of the rice cooker, the method further comprises:
determining a starting time for starting the cooking function of the rice cooker such that the cooking function is activated automatically when the starting time is reached.

5. The method according to claim 4, wherein determining the starting time for starting the cooking function of the rice cooker comprises:
determining if a time that the rice and the water in the rice cooker meet the cooking condition is in a second time interval;
acquiring an alarm time set in an alarm device when the rice and the water in the rice cooker meet the cooking condition in the second time interval;
determining a starting time based on the acquired alarm time;
determining if a time that the rice and the water in the rice cooker meet the cooking condition is in a third time interval;
acquiring route information and road condition information corresponding to the route information between a specified smart device and the rice cooker when the rice and the water in the rice cooker meet the cooking condition in the third time interval;
calculating an arrival time of the specified smart device according to the route information and the road condition information;
determining the starting time based on the calculated arrival time;
determining a time the user had previously manually started the cooking function of the rice cooker as the starting time; and
determining a starting time automatically based on the most recent starting time.

6. The method according to claim 1, further comprising:
displaying prompt information to prompt whether an operation of starting the cooking function of the rice cooker is cancelled before starting the cooking function of the rice cooker; and
performing the operation of starting the cooking function of the rice cooker when an instruction for cancelling the operation of starting the cooking function of the rice cooker is not received within a second predetermined period of time.

7. The method according to claim 6, wherein the displaying prompt information comprises:
pushing the prompt information to a mobile terminal when it is detected that there is no user active in the one or more predetermined rooms;
pushing the prompt information to a smart television when it is detected that there is a user active in the one or more predetermined rooms; and
emitting one or more of a sound and light prompt via the rice cooker when it is detected that there is a user active in the one or more predetermined rooms.

8. A device for starting a rice cooker, comprising:
a processor; and
a memory for storing instructions executable by the processor, the processor configured to:
detect if rice and water in the rice cooker meet a cooking condition,
determine if a specified user operation is received when the rice and the water in the rice cooker meet the cooking condition, and
activate a cooking function of the rice cooker when a detection result corresponds to not receiving the specified user operation.

9. The device according to claim 8, wherein the processor is further configured to:
detect if there are weights in the rice cooker via a pressure sensor provided on a bottom of a pan of the rice cooker,
acquire a total mass of the weights when it is determined that there are weights in the rice cooker,
heat an inner pot of the rice cooker for a predetermined length of time based on the activated cooking function;
acquire a temperature variation value in the inner pot of the rice cooker before or after heating;
determine a ratio of the rice and the water in the rice cooker according to the temperature variation value and the total mass; and
detect if the rice and the water in the rice cooker meet the cooking condition based on the ratio of the rice and the water.

10. The device according to claim 8, wherein the processor is further configured to:
detect if an automatic starting condition is satisfied, wherein the automatic starting condition includes:
a user that has entered into a sleep state according to physiological parameters of the user detected by a wearable device,
no user activity in one or more predetermined rooms according to monitoring data of a security device in a smart home, and
a time that the rice and the water in the rice cooker meet the cooking condition is in a first time interval, and one or more predetermined lighting devices in the smart home is in a closed state.

11. The device according to claim 8, wherein the processor is further configured to:
determine a starting time for starting the cooking function of the rice cooker such that the cooking function is activated automatically when the starting time is reached.

12. The device according to claim 11, wherein the processor is further configured to:
determine if a time that the rice and the water in the rice cooker meet the cooking condition is in a second time interval,
acquire an alarm time set in an alarm device when the rice and the water in the rice cooker meet the cooking condition in the second time interval, and
determine a starting time based on the acquired alarm time,
determine if a time that the rice and the water in the rice cooker meet the cooking condition is in a third time interval,
acquire route information and road condition information corresponding to the route information between a specified smart device and the rice cooker when the rice and the water in the rice cooker meet the cooking condition in the third time interval,
calculate an arrival time of the specified smart device according to the route information and the road condition information, and
determine the starting time based on the calculated arrival time,
determine a time when the user had previously manually started the cooking function of the rice cooker last time as the starting time, and
determine a starting time automatically based on the most recent starting time.

13. The device according to claim 8, wherein the processor is further configured to:
display prompt information to prompt whether an operation of starting the cooking function of the rice cooker is cancelled before starting the cooking function of the rice cooker, and
perform the operation of starting the cooking function of the rice cooker when an instruction for cancelling the operation of starting the cooking function of the rice cooker is not received within a second predetermined period of time.

14. The device according to claim 13, wherein the processor is further configured to:
push the prompt information to a mobile terminal when it is detected that there is no user active in the one or more predetermined rooms,
push the prompt information to a smart television when it is detected that there is a user active in the one or more predetermined rooms, or
emit one or more of a sound and light prompt via the rice cooker when it is detected that there is a user active in the one or more predetermined rooms.

15. A non-transitory computer-readable storage medium storing computer-readable instructions that, when executed by a computer, cause the computer to perform the method comprising:
detecting if rice and water in a rice cooker meet a cooking condition;
determining if a specified user operation is received when the rice and the water in the rice cooker meet the cooking condition; and
activating a cooking function of the rice cooker when a detection result corresponds to not receiving the specified user operation.

16. The method according to claim 15, wherein the detecting if the rice and water in the rice cooker meet the cooking condition further comprises:
detecting if there are weights in the rice cooker via a pressure sensor provided on a bottom of a pan of the rice cooker;
acquiring a total mass of the weights when it is determined that there are weights in the rice cooker;
heating an inner pot of the rice cooker for a predetermined length of time based on the activated cooking function;
acquiring a temperature variation value in the inner pot of the rice cooker before or after heating;
determining a ratio of the rice and the water in the rice cooker according to the temperature variation value and the total mass; and
detecting if the rice and the water in the rice cooker meet the cooking condition based on the ratio of the rice and the water.

17. The method according to claim 15, wherein the method prior to starting the cooking function of the rice cooker further comprises:
detecting if an automatic starting condition is satisfied, wherein the automatic starting condition includes:
determining that a user has entered into a sleep state according to physiological parameters of the user detected by a wearable device;
determining that there is no user activity in one or more predetermined rooms according to monitoring data of a security device in a smart home; and
determining that a time that the rice and the water in the rice cooker meet the cooking condition is in a first time interval, and one or more predetermined lighting devices in the smart home is in a closed state.

18. The method according to claim 15, wherein before starting the cooking function of the rice cooker, the method further comprises:
determining a starting time for starting the cooking function of the rice cooker such that the cooking function is activated automatically when the starting time is reached.

19. The method according to claim 18, wherein determining the starting time for starting the cooking function of the rice cooker comprises:
determining if a time that the rice and the water in the rice cooker meet the cooking condition is in a second time interval;
acquiring an alarm time set in an alarm device when the rice and the water in the rice cooker meet the cooking condition in the second time interval;
determining a starting time based on the acquired alarm time;
determining if a time that the rice and the water in the rice cooker meet the cooking condition is in a third time interval;
acquiring route information and road condition information corresponding to the route information between a specified smart device and the rice cooker when the rice and the water in the rice cooker meet the cooking condition in the third time interval;
calculating an arrival time of the specified smart device according to the route information and the road condition information;
determining the starting time based on the calculated arrival time;
determining a time the user had previously manually started the cooking function of the rice cooker as the starting time; and
determining a starting time automatically based on the most recent starting time.

20. The method according to claim 15, further comprising:
displaying prompt information to prompt whether an operation of starting the cooking function of the rice cooker is cancelled before starting the cooking function of the rice cooker; and
performing the operation of starting the cooking function of the rice cooker when an instruction for cancelling the operation of starting the cooking function of the rice cooker is not received within a second predetermined period of time.
